(19) United States
(12) Patent Application Publication
(10) Pub. No.: US 2015/0366240 A1
(43) Pub. Date: Dec. 24, 2015

(54) SYSTEMS AND METHODS FOR CONCEALING MEDICATION AND MAKING TREATS

(71) Applicant: Kinn, Inc., Aliso Viejo, CA (US)

(72) Inventors: Allen Chandler Young, Encinitas, CA (US); Chi Hung Cao, San Diego, CA (US); Alexander James McKinnon, Aliso Viejo, CA (US)

(21) Appl. No.: 14/838,303

(22) Filed: Aug. 27, 2015

Related U.S. Application Data
(63) Continuation of application No. 13/554,147, filed on Jul. 20, 2012.

(51) Int. Cl. A23K 1/16; G09B 19/00; A23P 1/08

(52) U.S. Cl. CPC A23K 1/16; A23P 1/081; G09B 19/00

(57) ABSTRACT

Medication can be concealed using a device that comprises a food storage container, a nozzle, and a base. The food storage container typically stores a non-solid food product that can be used to conceal medication, dispense toppings, and make treats. Furthermore, the food storage container can be configured to mate with a nozzle, which could control the flow of the food product within the food storage container. The base comprises a cavity configured to receive an open capsule, wherein the non-solid food product can be dispensed via the nozzle of the food storage container.

This application is a continuation of U.S. patent application Ser. No. 13/554147 filed Jul. 20, 2012. This and all other extrinsic materials discussed herein are incorporated by reference in their entirety.

### FIELD OF THE INVENTION

The field of the invention is related to the concealment of medication.

### BACKGROUND

The following background discussion includes information that may be useful in understanding the present invention. It is not an admission that any of the information provided herein is prior art or relevant to the presently claimed invention, or that any publication specifically or implicitly referenced is prior art.

Administering oral medication can be rather difficult, especially when the pill must be fed to a pet or other animal. Although the pill can be reduced by splitting or crushing the pill, many animals will still refuse to eat the medication because of the sight or smell or the medicine.

Various solutions are known in the art that attempt to conceal medicine, such as those described in U.S. Pat. No. 4,857,333 to Harold, U.S. Pat. No. 5,674,515 to Wesenhagen, U.S. Pat. No. 5,853,757 to Durand, et al., U.S. pat. publ. no. 2005/0175685 to Grandinetti (publ. Aug. 2005), U.S. pat. publ. no. 2004/0247665 to Smith et al, and UK pat. publ. no. 2410686 to Hasirci. However, these solutions are often messy and can be difficult to use, and can leave food residue on a user's hand. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Thus, there is still a need for systems and methods for quickly and easily making treats that can effectively conceal medicine while reducing clean-up.

### SUMMARY OF THE INVENTION

The inventive subject matter provides apparatus, systems and methods in which one can conceal medication within a treat. Preferred systems include a food storage container, a nozzle, and a base configured to receive a pill. In typical embodiments, the food storage container could store a non-solid food product. Preferably, the nozzle is configured to mate with the food storage container, such that the nozzle controls a flow of the food product from the food storage container.

Moreover, the base can include a cavity capable of receiving an open capsule. The open capsule can receive one or more pills or a portion thereof, whether in solid, broken, or in a powder form. Food product can then be placed within the capsule and about the one or more pills, by first coupling the nozzle to the base and causing food product to flow from the food storage container into the open capsule.

In another aspect, methods are contemplated for facilitating the concealment of a medication and/or making treats. Preferred methods comprise providing a food storage container comprising a non-solid food product. A user can be instructed to couple the food storage container with a nozzle. In a typical operation, the nozzle is configured to direct a flow of the food product from the food storage container into an open capsule, which thereby conceals a medication in the open capsule.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a perspective view of an exemplary embodiment of a medication concealing device.

FIG. 2 is a perspective view of an exemplary embodiment of a nozzle having a valve.

FIG. 3 is an exploded view of an exemplary medication concealing device further comprising a bottom having a non-slip surface.

FIG. 4 is a perspective view of an exemplary embodiment of a capsule holder having at least two cavities.

FIG. 5 is a flow chart of an exemplary method of facilitating the concealment of medication.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

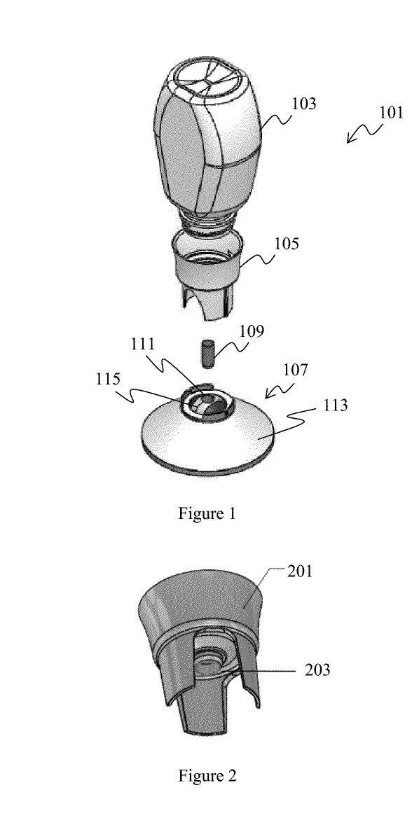

FIG. 1 illustrates an exemplary embodiment of a system 101 for making treats, which can advantageously be used to conceal medication. As used herein, the term “medication” includes drugs, herbs, supplements, and other orally ingested compounds. The system 101 can preferably include a base 107 configured to receive an open capsule or other edible, ingestible, and digestible container that is sized and dimensioned to receive a pill or a portion thereof.

Typically, the base 107 can have an outer housing 113 that preferably includes an opening on its upper surface. Although the specific dimensions can vary, it is preferred that base 107 has a height of between 5 cm to 7 cm, and a diameter of between 8 cm-12 cm. Outer housing 113 is preferably composed of a zinc alloy, although it is contemplated that the outer housing 113 can be made of any commercially suitable material(s) including, for example, stainless steel, aluminum, and other metals or metal composites, plastics or other polycarbonates, ceramic, and any combination(s) thereof. Although shown having an inverted cone-shape, it is contemplated that the outer housing 113 could be of any commercially suitable shape, such as a square or a pyramid, for example, so long as base 107 can maintain its horizontal stability during normal use. Base 107 preferably has a bottom surface that is at least partially covered with a non-stick material or is otherwise configured to increase a coefficient of friction between the bottom of the base 107 and the surface where the base 107 is sat.

Base 107 can further include a capsule holder 115 disposed within the outer housing 113 and that includes at least one cavity 111 and preferably between two and four cavities. It is contemplated that the capsule holder 115 can be rotatably coupled to the outer housing 113, such that the capsule holder 115 can rotate with respect to the outer housing 113. As shown in FIG. 1, the opening of the outer housing 113 thereby allows access to the cavity 111. Furthermore, where the capsule holder 115 includes multiple cavities, it is preferred that the cavities each have a different volume from that of the other cavities. In such embodiments, by rotating the capsule holder 115 with respect to the base 107, the differently sized cavities can be accessed.

The at least one cavity 111 is preferably sized and dimensioned to receive a capsule 109 or other edible, ingestible, and digestible containers. The capsule 109 can vary in size. For example, the capsule 109 can comprise of small, medium, large, and extra large sizes, wherein the size of the capsule to be used is determined by the weight of the animal/person that will consume the capsule 109. Preferably, the capsule 109 is large enough to receive a pill or tablet, which could be whole, split, crushed, or pulverized. Rather than a generally cylindrical shape, the open capsule can be of different shapes including, for example, an open cylinder, rectangle, cone, and so forth. In other contemplated embodiments, the open capsule 109 could be a commercially suitable sack or bag.

In further contemplated embodiments, capsule 109 can be designed to disintegrate quickly when in contact with water, which effectively simulates a natural process of ingestion and digestion. However, other materials can be used for the open capsule 109 to control the disintegration of the open capsule 109.

To prepare a treat and/or conceal the one or more pills within the capsule 109 or other container, a food product from a food storage container can be disposed about the pill(s) within the capsule 109. Preferably, system 101 includes a food storage container 103 that can be used to store a non-solid food product, and that couples to a nozzle 105 to thereby direct a flow of the food product from the container 103.

It is contemplated that the food storage container 103 can store any of a wide variety of non-solid food products. As just a few examples, the food storage container 103 could store a peanut butter mixture, a fruit treat, fish, vegetables, chicken, various oils such as flax seed oil, olive oil, cod liver oil, and safflower oil or any combinations thereof. Furthermore, one should appreciate that the food products can be for consumption by humans or animals.

Although shown having a middle portion that extends outwardly, the food storage container 103 could comprise any commercially suitable shape. The volume of the container 103 can also vary depending on the amount of food product to be stored. Preferably, the container 103 is formed from plastics or other polycarbonates, and is injection molded, although any commercially suitable process could be used. The container 103 could alternatively be formed of a different material, although it is preferred that the container 103 be flexible, such that the container 103 can be compressed to thereby cause food product to exit the container 103.

Container 103 can be coupled to a nozzle 105 via a threaded coupling or any other commercially suitable coupling including, for example, a latch or other mechanical fastener, glue or other adhesive, and so forth. In this manner, nozzle 105 can be easily removed from the container 103 such as for replacement, cleaning, or refilling of the container 103 or nozzle 105. Alternatively, it is contemplated that nozzle 105 could be integral with container 103.

The nozzle 105 can be of any commercially suitable size and dimension, but preferably is configured to mate with the base 107 to help guide food product from the container 103 to the capsule 109 held in cavity 111. For example, nozzle 105 can be conical, cylindrical, bell shape, annular, or some other commercially suitable shape. Moreover, the material of the nozzle 105 can be the same as that of the food storage container 103. However, the nozzle 105 could be formed of a different polymer (e.g., an amorphous copolyester), or other commercially suitable material such as ceramic, metals, metal composites, or any combination(s) thereof.

Typically, base 107 is configured to receive the nozzle 105, such that the non-solid food product flows through the nozzle 105 and into the open capsule 109. Preferably nozzle 105 includes one or more projections or wings that contact an outer or inner perimeter of at least a portion of the base 107. For example, as shown in FIG. 1, nozzle 105 can include three projections, each of which contacts an outer perimeter of a mouth of base 107 to thereby help maintain a position of the container 103 and nozzle 105 with respect to the base 107. However, in other contemplated embodiments, the projections could be configured to mate with an inner portion of the mouth of base 107, or another portion of base 107 entirely. It is further contemplated that the nozzle 105 could comprise a single projection, two projections, or four or more distinct projections, such that nozzle 105 can be removably coupled to the base 107.

By aligning the nozzle 105 with the base 107, food product can precisely flows from the container 103 to capsule 109 and thereby can surround a pill, if any, within the capsule 109, all with little or no mess. However, other contemplated embodiments include, for example, a funnel-type nozzle where the tip of the nozzle is partially within the capsule 109 when the non-solid food product is transferred or coupling the nozzle to the capsule 109.

In FIG. 2, an embodiment of a nozzle 201 is illustrated having a valve 203. The valve 203 is preferably configured to restrict a flow of the non-solid food product through the nozzle 201. It is contemplated, that the valve 203 can be used to control the dimensions of the flow of non-solid food product. Although valve 203 preferably comprises a check valve, any commercially suitable valve could be used, including electrically-operated valves.

It is contemplated that valve 203 could be removably coupled to the nozzle 201, such that the valve 203 can be removed for cleaning or replacement as needed. In addition, it is contemplated that nozzle 201 could receive different valves 203 depending on the viscosity of the food product to be regulated by the valve. For example, a first valve could be used for food product having a viscosity less than a defined amount, and a second valve could be used for those food products having a great viscosity.

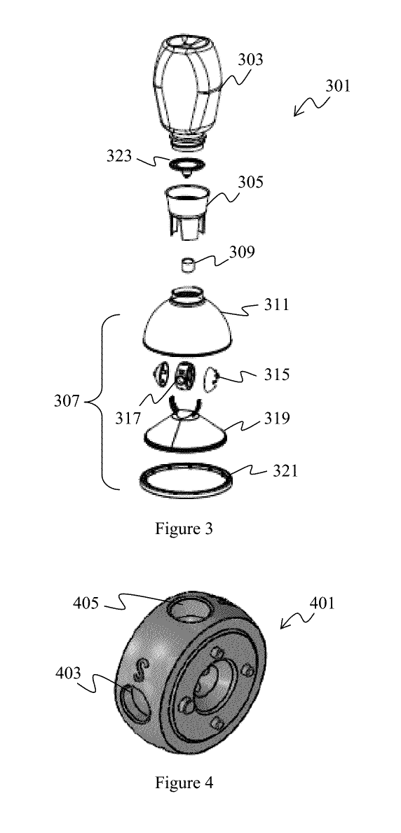

Another embodiment of a system 301 for making treats is shown in FIG. 3. System 301 can include a food storage container 303, a nozzle 305 with valve 323, and a base 307. As discussed above with respect to FIG. 1, base 307 can include a capsule holder 317 that is rotatably coupled to base 307, and specifically inner housing 319. Preferably, the inner housing 319 and capsule holder 317 are configured such that the capsule holder 317 has a plurality of discrete stops that allow precise alignment of a cavity of the capsule holder 317 with the opening of outer housing 311. The capsule holder 317 can have first and second ends 315 that facilitate coupling of the capsule holder 317 to base 307. In this manner, the capsule holder 317 can rotate with respect to the housing, such that differently-sized cavities within the capsule holder 317 can be accessed via an aperture in an outer housing 311 of base 307.

Furthermore, the base 307 can comprise a bottom portion 321 having a non-slip surface. This can advantageously be used to help maintain a position of the base 307 while the treats are being made. With respect to the remaining numerals in FIG. 3, the same considerations for like components with like numerals of FIG. 1 apply.

FIG. 4 illustrates an embodiment of a capsule holder 401 having a first cavity 403 and a second cavity 405. Although not shown, it is contemplated that the capsule holder 401 could include three or more cavities, and preferably includes at least four cavities. It is especially preferred that each of the cavities can have a volume that is different from the other cavities of the capsule holder 401. Thus, it is contemplated that the second cavity 405 can have a greater volume than a volume of the first cavity 403.

Preferably, the capsule holder 401 is rotatable within an inner housing, such that at a first position, the first cavity 403 can be accessed, and at a second position the second cavity 405 can be accessed. Alternatively, it is contemplated that the capsule holder 401 can be rotated to show two or more cavities through an opening of the outer housing. Nevertheless, one should appreciate that having cavities of different volumes allows the flexibility of using capsules of different sizes, such as for a system for making treats and/or concealing medication. With respect to the remaining numerals in FIG. 4, the same considerations for like components with like numerals of FIG. 1 apply.

In another aspect of the inventive subject matter, methods for making treats and/or facilitating the concealment of one or more medications are disclosed. Contemplated methods include step 501 of providing a food storage container that is capable of storing a non-solid food product. Thereafter, a user is instructed in step 503 to couple the food storage container with a nozzle. Preferably, the nozzle is configured to direct a flow of the food product from the food storage container into an open capsule to thereby conceal one or more medications in the open capsule.

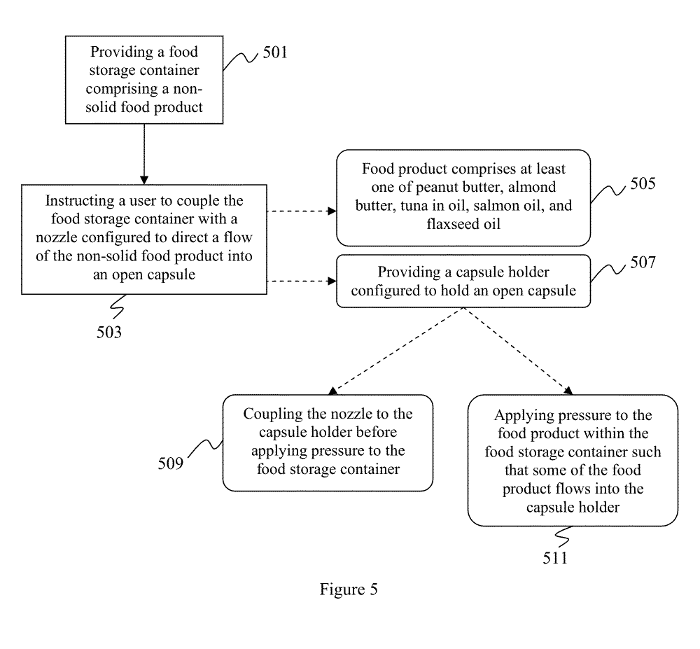

Additionally, a capsule holder can also be provided in step 507 to hold the open capsule. In such embodiments, the nozzle can be coupled in step 509 to the capsule holder before applying pressure to the food storage container. Alternatively, pressure can be applied in step 511 to the food product within the food storage container such that at least some of the food product flows from the food storage container to the capsule holder. With respect to the remaining numerals in FIG. 5, the same considerations for like components with like numerals of FIG. 1 apply.

In yet another aspect of the inventive subject matter, methods for concealing medications, making treats, and dispensing toppings are disclosed. It is contemplated that a user can fill a food storage container with non-solid food product or simply purchase a pre-filled container. Thereafter, an open capsule can be inserted into a cavity of a capsule holder of the treat maker. In preferred embodiments, the size of the open capsule correlates with a cavity in the capsule holder, where the capsule holder can be rotated to find an appropriately sized cavity. The user can then attach a nozzle to the food storage container. Food product can then be forced from the container through the nozzle and into the capsule. By using the systems and methods discussed herein, creation of treats is greatly simplified and the potential for mess is reduced, as the nozzle allows for precise alignment with the base and thereby ensures that the food product will flow into the capsule.

The food product within the container can be dispensed at a variety of locations via the nozzle of the food storage container. For instance, a user can apply pressure to the food storage container to dispense the non-solid food product into an open capsule to create a treat by at least partially filling the capsule and then closing the capsule. In another embodiment, the user can add a whole, crushed, split, or pulverized medication into a capsule and cover the medication with a food product to disguise the medication and encourage a human or animal to ingest the medication. In yet another example, a user can simply apply pressure to the food storage container and dispense the non-solid food product as a topping for food (e.g., dispense on to a bowl of food).

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A treat making device configured to conceal medication, comprising:
a food storage container configured to store a non-solid food product;
a nozzle configured to mate with the food storage container, such that the nozzle controls a flow of the food product from the food storage container; and
a base having a cavity configured to allow receipt of different-sized capsules.

2. The device of claim 1, wherein the food storage container is flexible.

3. The device of claim 1, wherein the food storage container is solid.

4. The device of claim 1, wherein the nozzle further comprises a valve configured to restrict a flow of the food product through the nozzle.

5. The device of claim 1, wherein the base includes a bottom portion having a non-slip surface.

6. The device of claim 1, wherein the base further comprises an outer housing coupled to a capsule holder that includes the cavity and a second cavity, and wherein the capsule holder is rotatable with respect to the housing.

7. The device of claim 1, wherein the food product comprises at least one of peanut butter, almond butter, tuna in oil, salmon oil, and flaxseed oil.

8. The device of claim 1, wherein the capsules are is sized and dimensioned to receive a medication.

9. A device for facilitating concealment of a medication using a non-solid food product, comprising:
an outer housing having an opening; and
a capsule holder coupled to the outer housing and that includes a variable-sized cavity configured to receive an open capsule, wherein the capsule holder is at least partially disposed within the outer housing such that the cavity is accessible via the opening.

10. The device of claim 9, wherein the capsule holder includes the cavity and a second cavity having a volume that is greater than a volume of the cavity.

11. The device of claim 10, wherein the capsule holder is rotatable within the outer housing, and wherein the cavity is accessible via the opening when the capsule holder is in a first position, and wherein the second cavity is accessible via the opening when the capsule holder is in a second position.

12. The device of claim 9, wherein the outer housing comprises a bottom portion having a non-slip surface.

13. The device of claim 9, further comprising a food storage container coupled to a nozzle, and wherein the outer housing is configured to receive the nozzle.

14. The device of claim 13, wherein the food storage container comprises at least one of peanut butter, almond butter, tuna in oil, salmon oil, and flaxseed oil.

15. The device of claim 9, wherein the outer housing has a conically-shaped vertical cross-section.

16. A method of preparing a treat, comprising:
providing a food storage container comprising a non-solid food product; and
instructing a user to couple the food storage container with a nozzle configured to direct a flow of the food product from the food storage container into an open container to at least partially fill the open container with the food product.

17. The method of claim 16, further comprising providing a capsule holder configured to hold the open container.

18. The method of claim 17, further comprising coupling the nozzle to a base coupled to the capsule holder before applying pressure to the food storage container.

19. The method of claim 16, further comprising:
inserting medication within the open container before at least partially filling the open container with the food product; and
closing the open container.

20. The method of claim 16, further comprising at least partially covering a second food product with at least some of the food product within the food storage container.
